(19) United States
(12) Patent Application Publication
(10) Pub. No.: US 2013/0273507 A1
(43) Pub. Date: Oct. 17, 2013

(54) CONSUMER INFORMATION SYSTEM FOR NUTRITIONAL SUBSTANCES

(71) Applicant: Eugenio Minvielle, Rye, NY (US)

(72) Inventor: Eugenio Minvielle, Rye, NY (US)

(21) Appl. No.: 13/485,878

(22) Filed: May 31, 2012

Related U.S. Application Data
(60) Provisional application No. 61/624,800, filed on Apr. 16, 2012.
(60) Provisional application No. 61/624,980, filed on Apr. 16, 2012.
(60) Provisional application No. 61/624,989, filed on Apr. 16, 2012.

(51) Int. Cl. G06F 17/30; G09B 19/00

(52) U.S. Cl. 434/127; 707/705; 707/E17.005

(57) ABSTRACT

Disclosed herein is a consumer communication system for nutritional substances. The consumer information system obtains information regarding the nutritional substance being consumed by the consumer, and provides that information to the other constituents in the nutritional substance supply system.

### CROSS REFERENCE TO RELATED APPLICATIONS OR PRIORITY CLAIM

This application claims benefit under 35 U.S.C. 119(e) of U.S. Provisional Patent Application Ser. No. 61/624,800, filed Apr. 16, 2012; U.S. Provisional Patent Application Ser. No. 61/624,980, filed Apr. 16, 2012; and U.S. Provisional Patent Application, 61/624,989, filed Apr. 16, 2012, the contents of which are incorporated herein by reference in their entirety.

### FIELD OF THE INVENTION

The present inventions relate to consumer information systems for nutritional substances using information regarding source, preservation and current information, prior transformation information, consumer preference information, including recipe information for tracking consumer's needs and preferences, and/or providing feedback to harvesters, preservers, transformers and conditioners of nutritional substance.

### BACKGROUND OF THE INVENTION

Nutritional substances are traditionally grown (plants), raised (animals) or synthesized (synthetic compounds). Additionally, nutritional substances can be found in a wild, non-cultivated form, which can be caught or collected. While the collectors and creators of nutritional substances generally obtain and/or generate information about the source, history, caloric content and/or nutritional content of their products, they generally do not pass such information along to the users of their products. One reason is the nutritional substance industries have tended to act like “silo” industries. Each group in the food and beverage industry: growers, packagers, processors, distributors, retailers, and preparers work separately, and either shares no information, or very little information, between themselves. There is generally no consumer access to, and little traceability of, information regarding the creation and/or origin, preservation, processing, preparation, or consumption of nutritional substances. It would be desirable for such information be available to the consumers of nutritional substances, as well as all participants in the food and beverage industry—the nutritional substance supply system.

While the nutritional substance supply system has endeavored over the last 50 years to increase the caloric content of nutritional substances produced (which has help reduce starvation in developing countries, but has led to obesity problems in developed countries), maintaining, or increasing, the nutritional content of nutritional substances has been a lower priority. Caloric content refers to the energy in nutritional substances, commonly measured in calories. The caloric content could be represented as sugars and/or carbohydrates in the nutritional substances. The nutritional content of foods and beverages, as used herein, refers to the non-caloric content of these nutritional substances which are beneficial to the organisms which consume these nutritional substances. For example, the nutritional content of a nutritional substance could include vitamins, minerals, proteins, and other non-caloric components which are necessary, or at least beneficial, to the organism consuming the nutritional substances.

While there has recently been greater attention by consumer organizations, health organizations and the public to the nutritional content of foods and beverages, the food and beverage industry has been slow in responding to this attention. One reason for this may be that since the food and beverage industry operates as silos of those who create nutritional substances, those who preserve and transport nutritional substances, those who transform nutritional substances, and those who finally prepare the nutritional substances for consumption by the consumer, there has been no coordination of management of nutritional content. While each of these silo industries may be able to maintain or increase the nutritional content of the foods and beverages they handle, each silo industry has only limited information and control of the nutritional substances they receive, and the nutritional substances they pass along.

As consumers better understand their need for nutritional substances with higher nutritional content, they will start demanding that the food and beverage industry offer products which include higher nutritional content, and/or at least information regarding nutritional content of such products. In fact, consumers are already willing to pay higher prices for higher nutritional content. This can be seen at high-end grocery stores which offer organic, minimally processed, fresh, non-adulterated nutritional substances. Further, as societies and governments seek to improve their constituents' health and lower healthcare costs, incentives and/or mandates will be given to the food and beverage industry to track, maintain, and/or increase the nutritional content of nutritional substances they handle. There will be a need, not only within each food and beverage industry silo to maintain or improve the nutritional content of their products, but an industry-wide solution to allow the management of nutritional content across the entire cycle from creation to consumption. In order to manage the nutritional content of nutritional substances across the entire cycle from creation to consumption, the nutritional substance industry will need to identify, track, measure, estimate, preserve, transform, condition, and record nutritional content for nutritional substances. Of particular importance is the measurement, estimation, and tracking of changes to the nutritional content of a nutritional substance from creation to consumption. This information could be used, not only by the consumer in selecting particular nutritional substances to consume, but could be used by the other food and beverage industry silos, including creation, preservation, transformation, and conditioning, to make decisions on how to create, handle and process nutritional substances. Additionally, those who sell nutritional substances to consumers, such as restaurants and grocery stores, could market and price nutritional substances with higher nutritional content, or minimally degraded nutritional content.

For example, the grower of sweet corn generally only provides basic information as the variety and grade of its corn to the packager, who preserves and ships the corn to a producer for use in a ready-to-eat dinner. The packager may only tell the producer that the corn has been frozen as loose kernels of sweet corn. The producer may only provide the consumer with rudimentary instructions how to cook or reheat the ready-to-eat dinner in a microwave oven, toaster oven or conventional oven, and only tell the consumer that the dinner contains whole kernel corn among the various items in the dinner. Finally, the consumer of the dinner will likely keep her opinions on the quality of the dinner to herself, unless it was an especially bad experience, where she might contact the producer's customer support program to complain. Very minimal, or no, information on the nutritional content of the ready-to-eat dinner is passed along to the consumer. The consumer knows essentially nothing about changes (generally degradation) to the nutritional content of the sweet corn from creation, processing, packaging, cooking, preservation, preparation by consumer, and finally consumption by the consumer.

Consumers' needs are changing as consumers are demanding healthier foods, such as “organic foods.” Customers are also asking for more information about the nutritional substances they consume, such as specific characteristics' relating not only to nutritional content, but to allergens or digestive intolerances. For example, nutritional substances which contain lactose, gluten, nuts, dyes, etc. need to be avoided by certain consumers. However, the producer of the ready-to-eat dinner, in the prior example, has very little information to share other than possibly the source of the elements of the ready-to-eat dinner and its processing steps in preparing the dinner. Generally, the producer of the ready-to-eat dinner does not know the nutritional content and organoleptic state of the product after it has been reheated or cooked by the consumer. For example, the consumer may want to know what proportion of organoleptic properties and/or nutritional content the corn in the ready-to-eat dinner remain after cooking or reheating, and the change in nutritional content (usually a degradation). There is a need to preserve, measure, estimate, store and/or transmit such nutritional content information throughout the nutritional substance supply system.

The caloric and nutritional content information for a prepared food that is provided to the consumer is often minimal For example, when sugar is listed in the ingredient list, the consumer generally does receive any information about the source of the sugar, which can come from a variety of plants, such as sugarcane, beets, or corn, which will affect its nutritional content. Conversely, some nutritional information that is provided to consumers is so detailed, the consumer can do little with it. For example, this this of ingredients is from a nutritional label on a consumer product: Vitamins—A 355 IU 7%, E 0.8 mg 4%, K 0.5 mcg, 1%, Thiamin 0.6 mg 43%, Riboflavin 0.3 mg 20%, Niacin 6.0 mg 30%, B6 1.0 mg 52%, Foliate 31.5 mcg 8%, Pantothenic 7%; Minerals Calcium 11.6 1%, Iron 4.5 mg 25%, 211 mg 53%, Phosphorus 349 mg 35%, Potassium 476 mg 14%, Sodium 58.1 mg 2%, Zinc 3.7 mg 24%, Copper 0.5 mg 26%, Manganese 0.8 mg 40%, Selenium 25.7 mcg 37%; Carbohydrate 123 g, Dietary fiber 12.1 g, Saturated fat 7.9 g, Monosaturated Fat 2,1 g, Polysaturated Fat 3.6 g, Omega 3 fatty acids 108 g, Omega 6 fatty acids 3481, Ash 2.0 g and Water 17.2 g. (%=Daily Value). There is a need to provide information about nutritional substances in a meaningful manner. Such information needs to be presented in a manner that meets the specific needs of a particular consumer. For example, consumers with a medical condition, such as diabetes, would want to track specific information regarding sugar and nutrients in the foods and beverages they consume.

If fact, each silo in the food and beverage industry already creates and tracks some information, including caloric and nutritional information, about their product internally. For example, the famer who grew the corn knows the variety of the seed, condition of the soil, the source of the water, the fertilizers and pesticides used, and can measure the caloric and nutritional content at creation. The packager of the corn knows when it was picked, how it was transported to the packaging plant, how the corn was preserved and packaged before being sent to the ready-to-eat dinner producer, when it was delivered to the producer, and what degradation to caloric and nutritional content has occurred. The producer knows the source of each element of the ready-to-eat dinner, how it was processed, including the recipe followed, and how it was preserved and packaged for the consumer. Not only does such a producer know what degradation to caloric and nutritional occurred, the producer can modify its processing and post-processing preservation to minimally affect nutritional content. The preparation of the nutritional substance for consumption can also degrade the nutritional content of nutritional substances. Finally, the consumer knows how she prepared the dinner, what condiments were added, and whether she did or did not enjoy it.

If there was a mechanism to share this information, the quality of the nutritional substances, including caloric and nutritional content, could be preserved and improved. Consumers could be better informed about nutritional substances they select and consume, including the state of the nutritional substance throughout its lifecycle from creation to consumption. The efficiency and cost effectiveness of nutritional substances could also be improved. Feedback within the entire chain from creator to consumer could provide a closed-loop system that could improve quality (taste, appearance, and caloric and nutritional content), efficiency, value and profit. For example, in the milk supply chain, at least 10% of the milk produced is wasted due to safety margins included in product expiration dates. The use of more accurate tracking information, measured quality (including nutritional content) information, and historical environmental information could substantially reduce such waste. Collecting, preserving, measuring and/or tracking information about a nutritional substance in the nutritional substance supply system, would allow needed accountability. There would be nothing to hide.

As consumers are demanding more information about what they consume, they are asking for products that have higher nutritional content and more closely match good nutritional requirements, and would like nutritional products to actually meet their specific nutritional requirements. While grocery stores, restaurants, and all those who process and sell food and beverages may obtain some information from current nutritional substance tracking systems, such as labels, these current systems can provide only limited information.

All through the nutritional substance supply and consumption chain the various suppliers benefit from feedback from consumers further up the supply chain. However, such feedback is disorganized and haphazard and can only be traced generally to the actual nutritional substances being commented on.

An important issue in the creation, preservation, transformation, conditioning, and consumption of nutritional substances are the changes that occur in nutritional substances due to a variety of internal and external factors. Because nutritional substances are composed of biological, organic, and/or chemical compounds, they are generally subject to degradation. This degradation generally reduces the nutritional, organoleptic, and/or aesthetic values of nutritional substances. While not always true, nutritional substances are best consumed at their point of creation. However, being able to consume nutritional substances at the farm, at the slaughterhouse, at the fishery, or at the food processing plant is at least inconvenient, if not impossible. Currently, the food and beverage industry attempts to minimize the loss of nutritional value (often through the use of additives or preservatives), and/or attempts to hide this loss of nutritional value from consumers.

Overall, the examples herein of some prior or related systems and their associated limitations are intended to be illustrative and not exclusive. Other limitations of existing or prior systems will become apparent to those of skill in the art upon reading the following Detailed Description.

### OBJECTS OF THE INVENTION

It is an object of the present invention to obtain consumer feedback on the consumption of the nutritional substance and provide such feedback to one or more of the nutritional substance creator, packager, transformer and/or conditioner.

An additional object of the present invention is to create a multi-dimensional database of such information for use and analysis by the nutritional substance creator, packager, transformer and/or conditioner.

It is an object of the present invention to minimize and/or track degradation of nutritional, organoleptic, and/or aesthetic value of nutritional substances, and/or collect, store, and/or transmit information regarding this degradation.

### SUMMARY OF THE INVENTION

In one embodiment of the present invention, consumer feedback information regarding consumed nutritional substances is collected and correlated to the source, packaging, transformation and/or conditioning information. Such information could be made available to the creator, packager, transformer and/or conditioner of the nutritional substance.

In another embodiment of the present invention, such correlated information would be stored and analyzed in a multi-dimensional database.

The an embodiment of the present invention provides a system for the creation, collection, storage, transmission, and/or processing of information regarding nutritional substances so as to improve, maintain, or minimize degradation of nutritional, organoleptic, and/or aesthetic value of nutritional substances. Additionally, the present invention provides such information for use by the creators, preservers, transformers, conditioners, and consumers of nutritional substances. The nutritional information creation, preservation, and transmission system of the present invention should allow the nutritional substance supply system to improve its ability to minimize degradation of nutritional, organoleptic and/or aesthetic value of the nutritional substance, and/or inform the consumer about such degradation. While the ultimate goal of the nutritional substance supply system is to minimize degradation of nutritional, organoleptic and/or aesthetic value, an interim goal should be providing consumers with significant information regarding degradation of nutritional substances consumers select and consume. Entities within the nutritional substance supply system who provide such information regarding nutritional substance degradation will be able to differentiate their products from those who obscure and/or hide such information. Additionally, such entities should be able to charge a premium for products which either maintain their nutritional, organoleptic, and/or aesthetic value, or supply more complete information.

Other advantages and features will become apparent from the following description and claims. It should be understood that the description and specific examples are intended for purposes of illustration only and not intended to limit the scope of the present disclosure.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 shows a schematic functional block diagram of a nutritional substance supply relating to the present invention;

FIG. 2 shows a graph representing a value of a nutritional substance which changes according to a change of condition for the nutritional substance;

FIG. 3 shows a schematic functional block diagram of the consumer information module 600 according to the present invention;

FIG. 4 shows a schematic functional block diagram of the consumer information module 600 according to an alternate embodiment of the present invention;

FIG. 5 shows a schematic functional block diagram of the consumer information module 600 according to the present invention;

FIG. 6 shows a schematic functional block diagram of the consumer information module 600 according to an alternate embodiment of the present invention;

FIG. 7 shows a schematic functional block diagram of the consumer information module 600 according to the present invention; and

FIG. 8 shows a schematic functional block diagram of the consumer information module 600 according to an alternate embodiment of the present invention.

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

### DETAILED DESCRIPTION OF THE INVENTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

The following discussion provides a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “controller,” “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

In some instances, the interconnection between modules is the internet, allowing the modules (with, for example, WiFi capability) to access web content offered through various web servers. The network may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

The modules in the systems can be understood to be integrated in some instances and in particular embodiments, only particular modules may be interconnected.

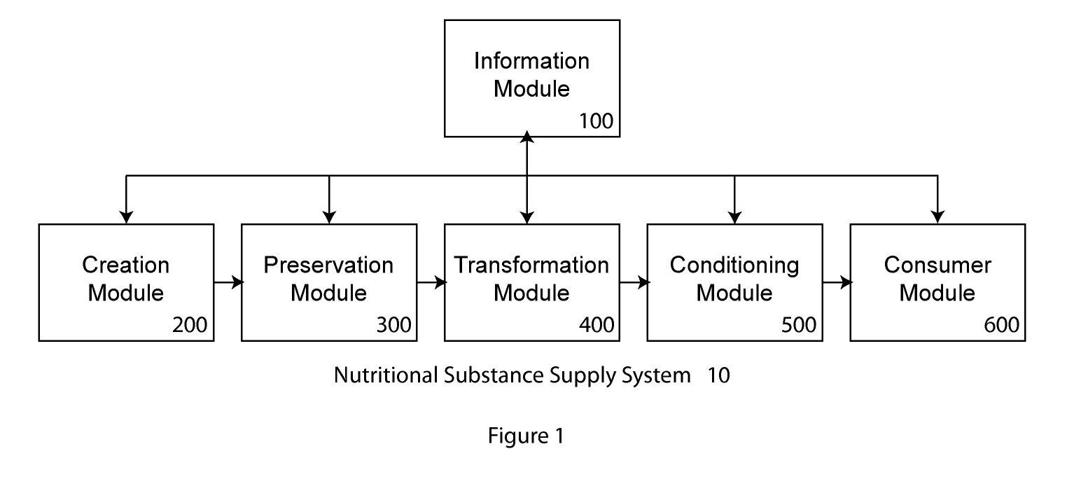

FIG. 1 shows the components of a nutritional substance industry 10. It should be understood that this could be the food and beverage and beverage ecosystem for human consumption, but could also be the feed industry for animal consumption, such as the pet food industry. A goal of the present invention for nutritional substance industry 10 is to create, preserve, transform and trace the qualitative, organoleptic and nutritional properties of nutritional substances through their creation, preservation, transformation, conditioning and consumption. While the nutritional substance industry 10 can be composed of many companies or businesses, it can also be integrated into combinations of business serving many roles, or can be one business or even individual.

Module 200 is the creation module. This can be system, organization, or individual which creates and/or originates nutritional substances. Examples of this module include a farm which grows produce. It can be a ranch which raises beef It can be an aquaculture far for growing shrimp. It could be a factory with synthesizes nutritional compounds. It could be collector of wild truffles. If could be a deep sea crab trawler.

Preservation module 300 is a preservation system for preserving and protecting the nutritional substances created by creation module 200. Once the nutritional substance has been created, generally, it will need to be packaged in some manner for its transition to other modules in the nutritional substances industry 10. While preservation module 300 is shown in a particular position in the nutritional substance industry 10, following the creation module 200, it should be understood that the preservation module 300 actual can be placed anywhere nutritional substances need to be preserved during their transition from creation to consumption.

Transformation module 400 is a nutritional substance processing system, such as a manufacturer who processes raw materials such as grains into breakfast cereals. Transformation module 400 could also be a ready-to-eat dinner manufacturer who receives the components for a ready-to-eat dinner from preservation module 300 and prepares them into a frozen dinner. While transformation module 400 is depicted as one module, it will be understood that nutritional substances may be transformed by a number of transformation modules 400 on their path to consumption.

Conditioning module 500 is a consumer preparation system for preparing the nutritional substance immediately before consumption by the consumer. Conditioning module 500 can be a microwave oven, a blender, a toaster, a convection oven, a cook, etc. It can also be systems used by commercial establishments to prepare nutritional substance for consumers such as a restaurant, an espresso maker, pizza oven, and other devices located at businesses which provide nutritional substances to consumers. Such nutritional substances could be for consumption at the business or for the consumer to take out from the business. Conditioning module 500 can also be a combination of any of these devices used to prepare nutritional substances for consumption by consumers.

Consumer module 600 collects information from the living entity which consumes the nutritional substance which has passed through the various modules from creation to consumption. The consumer can be a human being, but could also be an animal, such as pets, zoo animals and livestock, which are they themselves nutritional substances for other consumption chains. Consumers could also be plant life which consumes nutritional substances to grow.

Information module 100 receives and transmits information regarding a nutritional substance between each of the modules in the nutritional substance industry 10 including, the creation module 200, the preservation module 300, the transformation module 400, the conditioning module 500, and the consumer module 600. The nutritional substance information module 100 can be an interconnecting information transmission system which allows the transmission of information between various modules. Information module 100 contains a database where the information regarding the nutritional substance resides. Information module 100 can be connected to the other modules by a variety of communication systems, such as paper, computer networks, the internet and telecommunication systems, such as wireless telecommunication systems.

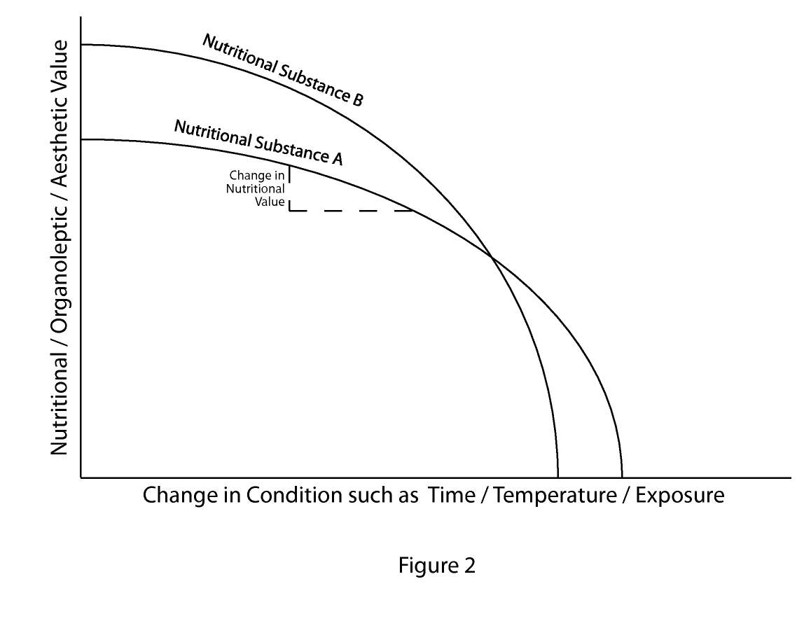

FIG. 2 is a graph showing the function of how a value of a nutritional substance varies over the change in a condition of the nutritional substance. Plotted on the vertical axis of this graph can be either the nutritional value, organoleptic value, or even the aesthetic value of a nutritional substance. Plotted on the horizontal axis can be the change in condition of nutritional substance over a variable such as time, temperature, location, and/or exposure to environmental conditions. This exposure to environmental conditions can include exposure to air, including oxygen, exposure to moisture, exposure to radiation such as heat or sunlight, or exposure to materials such as packaging. The function plotted as nutritional substance A could show the degradation of in the nutritional value of milk over time. Any point on this curve can be compared to another point to measure and/or describe the change in nutritional value. The plot of the degradation in nutritional value of nutritional substance B describes a nutritional substance which starts out with a higher nutritional value than nutritional substance A, but degrades over time more quickly than nutritional substance A.

If, in this example, where nutritional substance A and nutritional substance B are milk, this information regarding the nutritional substance degradation profile of each milk could be used by the consumer in the selection and/or consumption of the milk. If the consumer has this information at time zero when selecting a milk product for purchase, the consumer could consider when the consumer plans to consume the milk, whether that is on one occasion or multiple occasions. For example, if the consumer planned to consume the milk prior to the point when the curve represented by nutritional substance B crosses the curve represented by nutritional substance A, then the consumer should choose the milk represented by nutritional substance B because it has a higher nutritional value until it crosses the curve represented by nutritional substance A. However, if the consumer expects to consume at least some of the milk at a point in time after the time when the curve represented by nutritional substance B crosses the curve represented by nutritional substance A, then the consumer might choose to select the milk represented by the nutritional substance A, even though milk represented by nutritional substance A has a lower nutritional value than the milk represented by nutritional substance B at an earlier time. This change to a desired value in a nutritional substance over a change in the nutritional substance described in FIG. 2 can be measured and/or controlled throughout nutritional substance supply system 10 in FIG. 1.

In FIG. 1, Creation module 200 can dynamically encode nutritional substances to enable the tracking of nutritional, organoleptic, and/or aesthetic value of the nutritional substance. This dynamic encoding can replace and/or complement existing nutritional substance marking systems such as barcodes, labels, and/or ink markings. This dynamic encoding can be used to make nutritional substance information from creation module 200 available to information module 100 for use by preservation module 300, transformation module 400, conditioning module 500, and/or consumption module 600, which includes the ultimate consumer of the nutritional substance. One method of marking the nutritional substance by creation module 200 (or actually any other module in nutritional supply system 10) could include an electronic tagging system, such as the tagging system manufactured by Kovio of San Jose, Calif., USA. Such thin film chips can be used not only for tracking nutritional substances, by can include components to measure attributes of nutritional substances, and record and transmit such information. Such information may be readable by a reader including a satellite-based system. Such a satellite-based nutritional substance information tracking system could comprise a network of satellites with coverage of some or all the surface of the earth, so as to allow information module 100 real time, near real time updates about a particular nutritional substance.

Preservation module 300 includes packers and shippers of nutritional substances. The tracking of nutritional, organoleptic, and/or aesthetic values during the preservation period within preservation module 300 allows for dynamic expiration dates for nutritional substances. For example, expiration dates for dairy products are currently based generally only on time using assumptions regarding minimal conditions at which dairy products are maintained. This extrapolated expiration date is based on a worst-case scenario for when the product becomes unsafe to consume during the preservation period. In reality, the degradation of dairy products may be significantly less than this worst-case. If preservation module 300 could measure or derive the actual degradation information, the actual expiration date could be significantly later in time. This would allow the nutritional substance supply system to dispose of fewer products due to expiration dates. This ability to dynamically generate expiration dates for nutritional substances is of particular significance when nutritional substances contain few or no preservatives. Such products are highly valued throughout nutritional substance supply system 10, including consumers who are willing to pay a premium for nutritional substances with few or no preservatives.

By law, in many localities, food processors such as those in transformation module 400 are required to provide nutritional substance information regarding their products. Often, this information takes the form of a nutritional table applied to the packaging of the nutritional substance. Currently, the information in this nutritional table is based on averages or minimums for their typical product. Using the nutritional substance information from information module 100 provided by creation module 200, preservation module 300, and/or information from the transformation of the nutritional substance by transformation module 400, the food processor could include a nutritional table for the actual nutritional substance being supplied. The information in such a dynamically generated nutritional table could be used by conditioning module 500 in the preparation of the nutritional substance, and/or used by consumption module 600, so as to allow the ultimate consumer the ability to select the most desirable nutritional substance which meets their needs, and/or to track information regarding nutritional substances consumed.

The change in nutritional, organoleptic, and/or aesthetic value by conditioning module 500 is currently not tracked or provided to the consumer. However, using information provided by information module 100 from creation module 200, preservation module 300, transformation module 400, and/or information measured or generated by conditioning module 500, conditioning module 500 could provide consumer with the actual, and/or estimated change in nutritional, organoleptic, and/or aesthetic values of the nutritional substance. Such information regarding the change to nutritional, organoleptic and/or aesthetic value of the nutritional substance could be provided not only to the consumer, but could also be provided to information module 100 for use by creation module 200, preservation module 300, transformation module 400, so as to track, and possibly improve nutritional substances throughout the entire nutritional substance supply system 10.

The information regarding nutritional substances provided by information module 100 to consumption module 600 can replace or complement existing information sources such as recipe books, food databases like www.epicurious.com, and Epicurious apps. Through the use of specific information regarding a nutritional substance from information module 100, consumers can use consumption module 600 to select nutritional substances according to nutritional, organoleptic, and/or aesthetic values. This will allow consumers to make informed decisions regarding nutritional substance additives, preservatives, genetic modifications, origins, traceability, and other nutritional substance attributes. This information can be provided by consumption module 600 through personal computers, laptop computers, tablet computers, and/or smartphones. Software running on these devices can include dedicated computer programs, modules within general programs, and/or smartphone apps. An example of such a smartphone app regarding nutritional substances is the iOS ShopNoGMO from the Institute for Responsible Technology. This iPhone app allows consumers access to information regarding non-genetically modified organisms they may select. Additionally, consumption module 600 may provide information for the consumer to operate conditioning module 500 in such a manner as to preserve nutritional, organoleptic, and/or aesthetic value.

Through the use of nutritional substance information available from information module 100 nutritional substance supply system 10 can track nutritional, organoleptic, and/or aesthetic value. Using this information, nutritional substances travelling through nutritional substance supply system 10 can be dynamically valued and priced according to nutritional, organoleptic, and/or aesthetic values. For example, nutritional substances with longer expiration dates (longer shelf life) may be more highly valued than nutritional substances with shorter expiration dates. Additionally, nutritional substances with higher nutritional, organoleptic, and/or aesthetic values may be more highly valued, not just by the consumer, but also by each entity within nutritional substance supply system 10. This is because each entity will want to start with a nutritional substance with higher nutritional, organoleptic, and/or aesthetic value before it performs its function and passes the nutritional substance along to the next entity.

During the period of implementation of the present inventions, there will be nutritional substances being marketed which including the information, information-enabled nutritional substances, and nutritional substances which are not information enabled, dumb nutritional substances. Information-enabled nutritional substances would be available in virtual internet marketplaces, as well as traditional marketplaces. Because of information provided by information-enabled nutritional substances, entities within the nutritional substance supply system 10, including consumers, would be able to review and select information-enabled nutritional substances for purchase. It should be expected that, initially, the information-enabled nutritional substances would enjoy a higher market value and price than dumb nutritional substances. However, as information-enabled nutritional substances become more the norm, the cost savings from less waste due to degradation of information-enabled nutritional substances could lead to their price actually becoming less than dumb nutritional substances.

For example, the producer of a ready-to-eat dinner would prefer to use corn of a high nutritional, organoleptic, and/or aesthetic value in the production of its product, the ready-to-eat dinner, so as to produce a premium product of high nutritional, organoleptic, and/or aesthetic value. Depending upon the levels of the nutritional, organoleptic, and/or aesthetic values, the ready-to-eat dinner producer may be able to charge a premium price and/or differentiate its product from that of other producers. When selecting the corn to be used in the ready-to-eat dinner, the producer will seek corn of high nutritional, organoleptic, and/or aesthetic value from preservation module 300 that meets its requirements for nutritional, organoleptic, and/or aesthetic value. The packager/shipper of preservation module 300 would also be able to charge a premium for corn which has high nutritional, organoleptic, and/or aesthetic values. And finally, the packager/shipper of preservation module 300 will select corn of high nutritional, organoleptic, and/or aesthetic value from the grower of creation module 200, who will also be able to charge a premium for corn of high nutritional, organoleptic, and/or aesthetic values.

The nutritional, organoleptic, and/or aesthetic value for a nutritional substance tracked through nutritional substance supply system 10 through nutritional substance information from information module 100 can be preferably measured information. However, some or all such nutritional substance information may be derived through measurements of environmental conditions of the nutritional substance as it travelled through nutritional substance supply system 10. Additionally, some or all of nutritional substance information can be derived from data of other nutritional substances which have travelled through nutritional substance supply system 10. Finally, nutritional substance information can also be derived from laboratory experiments performed on other nutritional substances, which may approximate conditions and/or processes to which the actual nutritional substance has been exposed.

For example, laboratory experiments can be performed on bananas to determine effect on nutritional, organoleptic, and/or aesthetic value for a variety of environmental conditions bananas may be exposed to during packaging and shipment in preservation module 300. Using this experimental data, tables and/or algorithms could be developed which would predict the level of nutritional, organoleptic, and/or aesthetic values for a particular banana based upon information collected regarding the environmental conditions to which the banana was exposed during its time in preservation module 300. While the ultimate goal for nutritional substance supply system 10 would be the actual measurement of nutritional, organoleptic, and/or aesthetic values, use of derived nutritional, organoleptic, and/or aesthetic value from experimental information would allow more accurate tracking of nutritional, organoleptic, and/or aesthetic values while technology and systems are put in place to allow actual measurement.

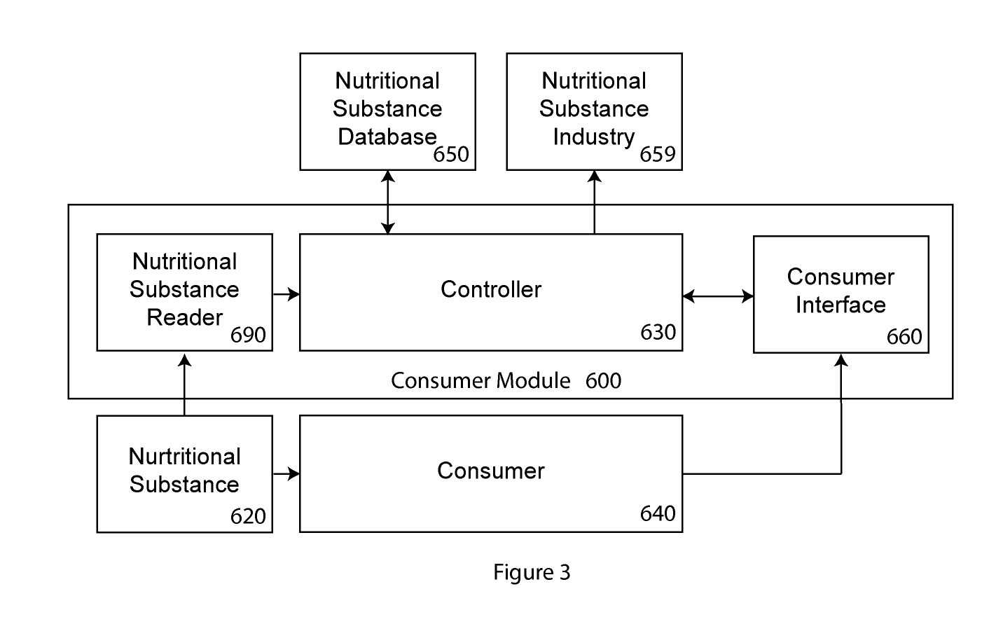

FIG. 3 shows an embodiment of consumer module 600 of the present invention. In the first embodiment of the present invention, consumer module 600 comprises nutritional substance reader 690, controller 630, and consumer interface 660. A nutritional substance 620 is read by nutritional substance reader 690 to obtain reference information regarding nutritional substance 620. Nutritional substance reader 690 provides such reference information to controller 630. Nutritional substance 620 is consumed by consumer 640. During, and/or following, consumption of nutritional substance 620 consumer 640 provides information to consumer interface 660. Such information is provided by consumer interface 660 to controller 630. Controller 630 correlates the nutritional substance information and the consumer information and provides the correlated information to nutritional substance industry 659. Such information may be used for improving nutritional substance 620, creating new nutritional substances, discontinue nutritional substances, an for marketing nutritional substance 620. Other uses of such correlated consumer information will be apparent to those in the nutritional substance industry 659. In a further embodiment described herein, consumer information may also be provided to the nutritional substance industry 659.

In an alternate embodiment, controller 630 references nutritional substance information 620 to nutritional substance database 650 to determine those in nutritional substance industry 659 who were involved in the creation, preserving, transforming, and/or conditioning of the nutritional substance 620. Controller 630 may provide the consumer information regarding nutritional substance 620 to those involved in the supply chain of nutritional substance 620.

Consumer module 600 can be implemented with discreet devices. For example, nutritional substance reader 690 could be an optical reader such as a barcode scanner or camera capable of discerning reference information. Nutritional substance reader 690 could also be a wireless signal reader, reading RFID labels, or near field IDs. Controller 630 can be a computer, microcontroller, personal computer, laptop computer, tablet computer, or smartphone. Consumer interface 660 can be a standalone touchpad display panel which allows interaction with the consumer, but is preferably integrated into controller 630.

Preferably, consumer module 600 is an integrated device such as a tablet computer or smartphone. In this case, nutritional substance reader 690 could be the camera located on the tablet or smartphone. Consumer interface 660 would be the touchscreen display of the tablet or smartphone. Finally, controller 630 would be the microprocessor in the tablet computer or smartphone. In this embodiment, the software to run consumer module 600 could be an app loaded onto the tablet or smartphone, designed to collect consumer information correlated to a known nutritional substance 620

In operation, consumer 640 would use the camera on the tablet computer or smartphone to read a barcode on nutritional substance 620 providing the reference information for nutritional substance 620. The tablet computer or smartphone would display an appropriate user interface so as to allow consumer 640 to provide information about her consumption of nutritional substance 620. Controller 630 could query nutritional substance database 650 using reference information regarding nutritional substance 620 to determine those in the nutritional substance industry who were involved in the supply chain for nutritional substance 620. Additionally, nutritional substance database 650 could contain information on what information to collect from consumer 640 of the particular nutritional substance 620 being referenced.

Such information could be provided through a connection to the internet accessed through the telecommunication system in the tablet computer or smartphone. Preferably, such a telecommunications connection to nutritional substance database 630 would be a wireless telecommunication system. The tablet computer or smartphone would then, in the same manner, provide the consumer information regarding her consumption of nutritional substance 620 to those in nutritional substance industry 659 involved in the supply chain of nutritional substance 620.

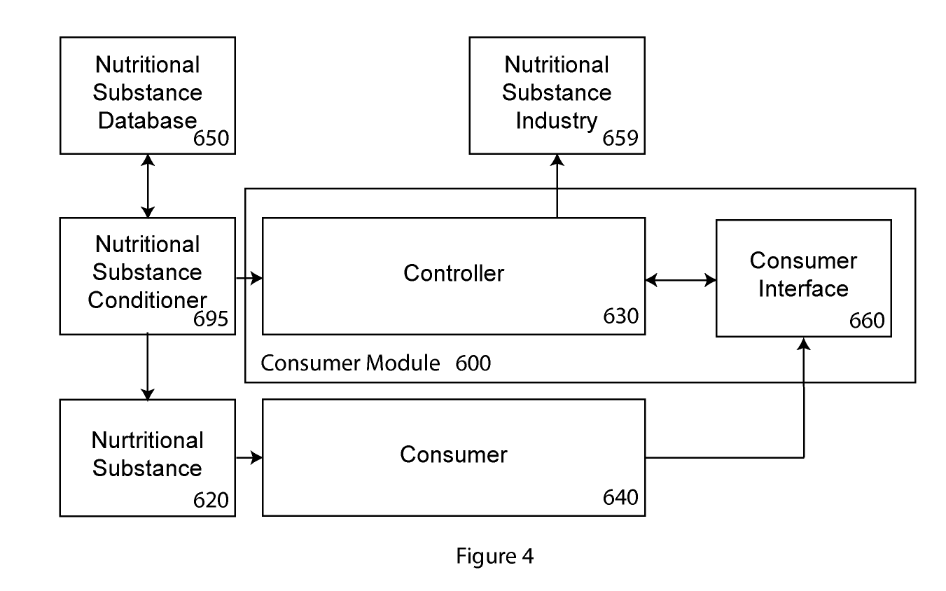

FIG. 4 shows an alternate embodiment of the present invention where nutritional substance 620 was conditioned by nutritional substance conditioner 695. In this case, nutritional substance conditioner 695 would already have information pertaining to nutritional substance 620, including information on how nutritional substance 620 was conditioned by nutritional substance conditioner 695.

In this embodiment, controller 630 receives such information regarding nutritional substance 620 and correlates it with consumer information from consumer interface 660 and provides it to nutritional substance industry 659.

For example, nutritional substance conditioner 695 conditions a ready-to-eat dinner. In the process of conditioning the ready-to-eat dinner, nutritional substance conditioner 695 receives various information, reads the reference tag on nutritional substance 620, the ready-to-eat dinner. Using this reference information, nutritional substance conditioner 695 receives, from nutritional substance database 650, information regarding nutritional substance 620, the ready-to-eat dinner. In this case, if the nutritional substance conditioner 695 is a nutritional substance information ready microwave oven, it would obtain from nutritional substance database 650 preparation information, organoleptic information, and/or nutritional information about the ready-to-eat dinner. Upon presentation of the ready-to-eat dinner to consumer 640, nutritional substance conditioner 695 also provides the information regarding the ready-to-eat dinner it received from nutritional substance database 650 along with information it collected regarding the conditioning of the ready-to-eat dinner by nutritional substance conditioner 695, to controller 630. If consumer module 600 is a standalone device such as a tablet computer or smartphone, the information from nutritional substance conditioner 695 could be transferred by means of a wireless local area network or Bluetooth connection. Consumer module 600, the smartphone for example, would obtain consumer information regarding the consumption of the nutritional substance 620. Since the smartphone knows what was consumed, it can obtain from consumer 640 information appropriate for the ready-to-dinner.

In the case of the ready-to-eat dinner, the consumer 640 could be asked specifically about the taste of the corn and the taste of the beef in the dinner, as well as their combination. Using such information and the information from the nutritional substance database 650, consumer module 600 can provide appropriate information to those in the nutritional substance industry 659 who were involved in the supply chain for nutritional substance 620.

In this embodiment, consumer module 600 could be part of nutritional substance conditioner 695. In this example, the nutritional substance information ready microwave oven would provide user interface 660 to receive consumer information regarding the nutritional substance 620 conditioned by nutritional substance conditioner 695. In such a case, controller 630 likely would be the same controller which operates nutritional substance conditioner 695.

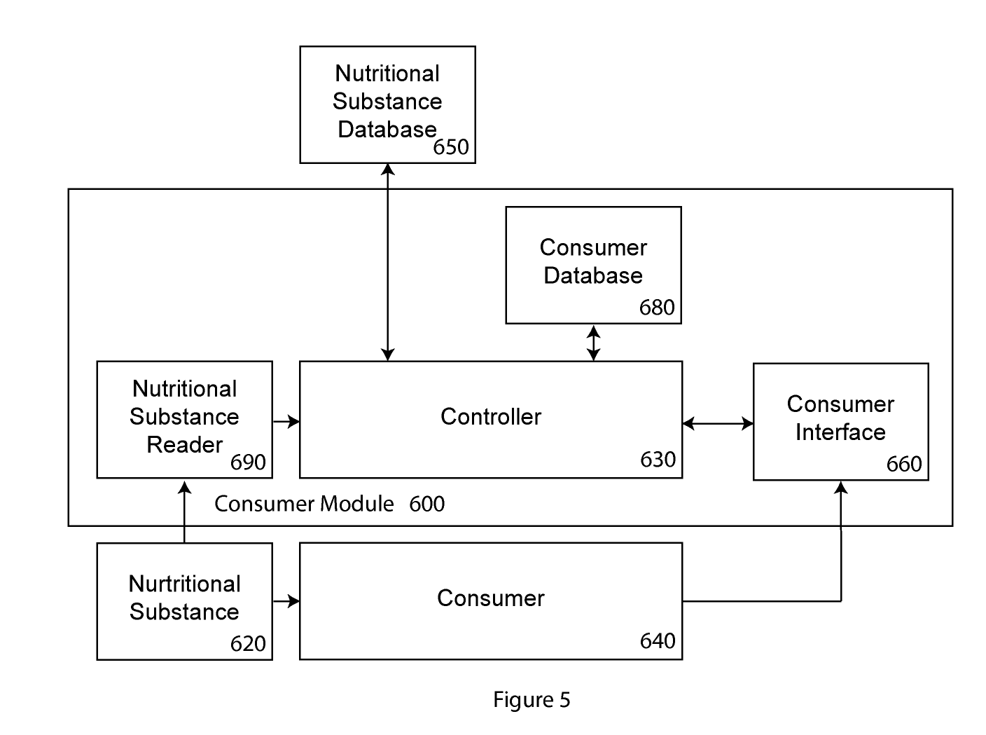

FIG. 5 shows an embodiment of consumer module 600 of the present invention. In the first embodiment of the present invention, consumer module 600 comprises nutritional substance reader 690, controller 630, and consumer interface 660. A nutritional substance 620 is read by nutritional substance reader 690 to obtain reference information regarding nutritional substance 620. Nutritional substance reader 690 provides such reference information to controller 630. Nutritional substance 620 is consumed by consumer 640. During, and/or following, consumption of nutritional substance 620 consumer 640 provides information to consumer interface 660. Such information is provided by consumer interface 660 to controller 630. Controller 630 correlates the nutritional substance information and the consumer information and provides the correlated information to nutritional substance industry 659. Such information may be used for improving nutritional substance 620, creating new nutritional substances, discontinue nutritional substances, an for marketing nutritional substance 620. Other uses of such correlated consumer information will be apparent to those in the nutritional substance industry 659. In a further embodiment described herein, consumer information may also be provided to the nutritional substance industry 659.

In an alternate embodiment, controller 630 references nutritional substance information 620 to nutritional substance database 650 to determine those in nutritional substance industry 659 who were involved in the creation, preserving, transforming, and/or conditioning of the nutritional substance 620. Controller 630 may provide the consumer information regarding nutritional substance 620 to those involved in the supply chain of nutritional substance 620.

Also included in consumer module 600 is consumer database 680. Consumer database 680 contains specific information regarding consumer 640. Correlated information regarding the consumption of nutritional substance 620 could be stored for future reference in consumer database 680. Such information could be used in collecting future consumer information. For example, if consumer 640 is very particular about a certain aspect of a nutritional substance 620, controller 630 could ask for additional and/or more specific information from consumer 640 about the nutritional substance 620 through consumer interface 660. As an example, consumer 640 is very particular about the texture of pasta. When nutritional substance 620 being consumed by consumer 640 contains pasta, controller 630, in response to historical consumer 640 information in consumer database 680, could ask for additional information regarding the texture of the pasta in nutritional substance 620, using consumer interface 660.

Consumer module 600 can be implemented with discreet devices. For example, nutritional substance reader 690 could be an optical reader such as a barcode scanner or camera capable of discerning reference information. Nutritional substance reader 690 could also be a wireless signal reader, reading RFID labels, or near field IDs. Controller 630 can be a computer, microcontroller, personal computer, laptop computer, tablet computer, or smartphone. Consumer interface 660 can be a standalone touchpad display panel which allows interaction with the consumer, but is preferably integrated into controller 630.

Preferably, consumer module 600 is an integrated device such as a tablet computer or smartphone. In this case, nutritional substance reader 690 could be the camera located on the tablet or smartphone. Consumer interface 660 would be the touchscreen display of the tablet or smartphone. Finally, controller 630 would be the microprocessor in the tablet computer or smartphone. In this embodiment, the software to run consumer module 600 could be an app loaded onto the tablet or smartphone, designed to collect consumer information correlated to a known nutritional substance 620

In operation, consumer 640 would use the camera on the tablet computer or smartphone to read a barcode on nutritional substance 620 providing the reference information for nutritional substance 620. The tablet computer or smartphone would display an appropriate user interface so as to allow consumer 640 to provide information about her consumption of nutritional substance 620. Controller 630 could query nutritional substance database 650 using reference information regarding nutritional substance 620 to determine those in the nutritional substance industry who were involved in the supply chain for nutritional substance 620. Additionally, nutritional substance database 650 could contain information on what information to collect from consumer 640 of the particular nutritional substance 620 being referenced.

Such information could be provided through a connection to the internet accessed through the telecommunication system in the tablet computer or smartphone. Preferably, such a telecommunications connection to nutritional substance database 630 would be a wireless telecommunication system. The tablet computer or smartphone would then, in the same manner, provide the consumer information regarding her consumption of nutritional substance 620 to those in nutritional substance industry 659 involved in the supply chain of nutritional substance 620.

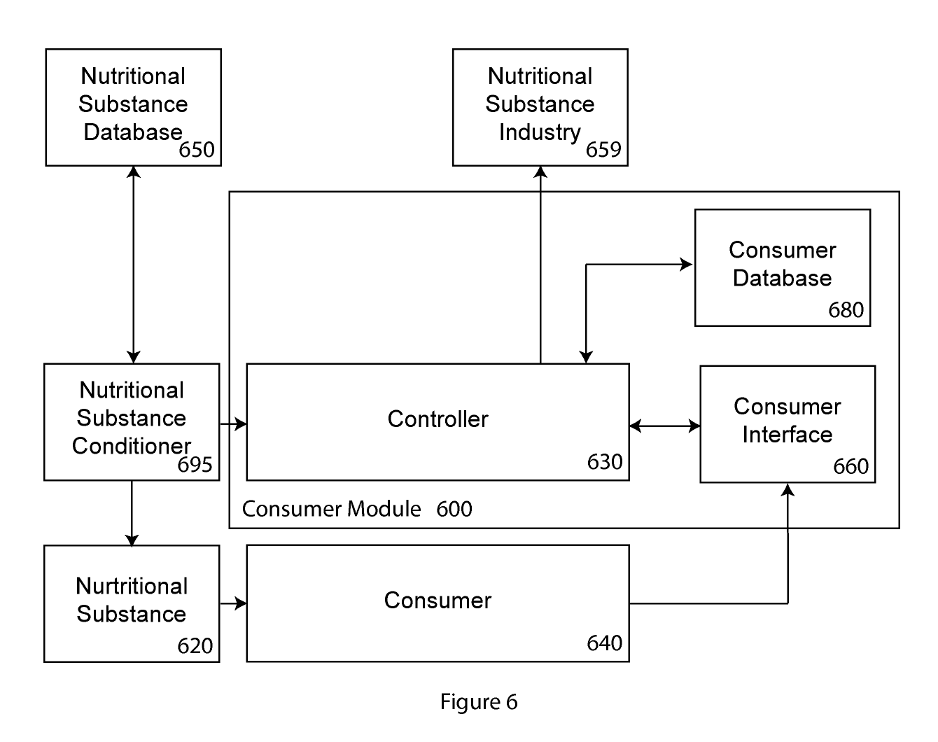

FIG. 6 shows an alternate embodiment of the present invention where nutritional substance 620 was conditioned by nutritional substance conditioner 695. In this case, nutritional substance conditioner 695 would already have information pertaining to nutritional substance 620, including information on how nutritional substance 620 was conditioned by nutritional substance conditioner 695.

In this embodiment, controller 630 receives such information regarding nutritional substance 620 and correlates it with consumer information from consumer interface 660 and provides it to nutritional substance industry 659.

For example, nutritional substance conditioner 695 conditions a ready-to-eat dinner. In the process of conditioning the ready-to-eat dinner, nutritional substance conditioner 695 receives various information, reads the reference tag on nutritional substance 620, the ready-to-eat dinner. Using this reference information, nutritional substance conditioner 695 receives, from nutritional substance database 650, information regarding nutritional substance 620, the ready-to-eat dinner. In this case, if the nutritional substance conditioner 695 is a nutritional substance information ready microwave oven, it would obtain from nutritional substance database 650 preparation information, organoleptic information, and/or nutritional information about the ready-to-eat dinner. Upon presentation of the ready-to-eat dinner to consumer 640, nutritional substance conditioner 695 also provides the information regarding the ready-to-eat dinner it received from nutritional substance database 650 along with information it collected regarding the conditioning of the ready-to-eat dinner by nutritional substance conditioner 695, to controller 630. If consumer module 600 is a standalone device such as a tablet computer or smartphone, the information from nutritional substance conditioner 695 could be transferred by means of a wireless local area network or Bluetooth connection. Consumer module 600, the smartphone for example, would obtain consumer information regarding the consumption of the nutritional substance 620. Since the smartphone knows what was consumed, it can obtain from consumer 640 information appropriate for the ready-to-dinner.

In the case of the ready-to-eat dinner, the consumer 640 could be asked specifically about the taste of the corn and the taste of the beef in the dinner, as well as their combination. Using such information and the information from the nutritional substance database 650, consumer module 600 can provide appropriate information to those in the nutritional substance industry 659 who were involved in the supply chain for nutritional substance 620.

In this embodiment, consumer module 600 could be part of nutritional substance conditioner 695. In this example, the nutritional substance information ready microwave oven would provide user interface 660 to receive consumer information regarding the nutritional substance 620 conditioned by nutritional substance conditioner 695. In such a case, controller 630 likely would be the same controller which operates nutritional substance conditioner 695.

It will be understood that subsets of the embodiment described herein can operate to achieve the goals stated herein. In one embodiment, nutritional substance sensor 380, internal sensor 370, external sensor 360, information storage module 330, controller 350, reader 340, and parts of container 310 are each electrical or electromechanical devices which perform each of the indicated functions. However, it is possible for some or all of these functions to be done using chemical and/or organic compounds. For example, a specifically designed plastic wrap for bananas can sense the exterior conditions of the package, the interior conditions of the package, and control gas flow through its surface so as to preserve and ripen the bananas.

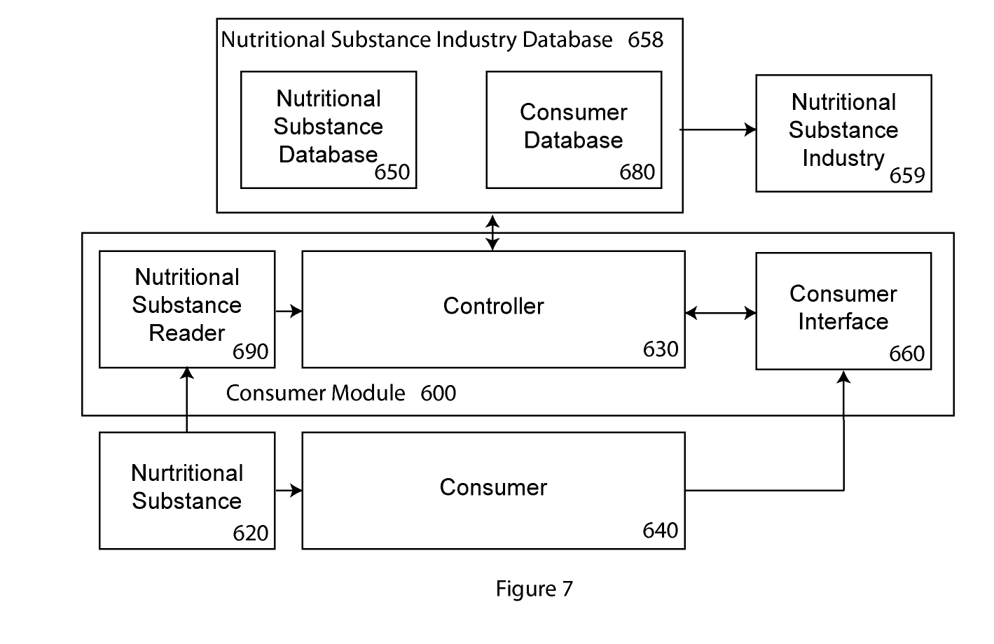

FIG. 7 shows an embodiment of consumer module 600 of the present invention. In the first embodiment of the present invention, consumer module 600 comprises nutritional substance reader 690, controller 630, and consumer interface 660. A nutritional substance 620 is read by nutritional substance reader 690 to obtain reference information regarding nutritional substance 620. Nutritional substance reader 690 provides such reference information to controller 630. Nutritional substance 620 is consumed by consumer 640. During, and/or following, consumption of nutritional substance 620 consumer 640 provides information to consumer interface 660. Such information is provided by consumer interface 660 to controller 630. Controller 630 correlates the nutritional substance information and the consumer information and provides the correlated information to nutritional substance industry 659. Such information may be used for improving nutritional substance 620, creating new nutritional substances, discontinue nutritional substances, an for marketing nutritional substance 620. Other uses of such correlated consumer information will be apparent to those in the nutritional substance industry 659. In a further embodiment described herein, consumer information may also be provided to the nutritional substance industry 659.

In an alternate embodiment, controller 630 references nutritional substance information 620 to nutritional substance database 650 to determine those in nutritional substance industry 659 who were involved in the creation, preserving, transforming, and/or conditioning of the nutritional substance 620. Controller 630 may provide the consumer information regarding nutritional substance 620 to those involved in the supply chain of nutritional substance 620.

Consumer module 600 can be implemented with discreet devices. For example, nutritional substance reader 690 could be an optical reader such as a barcode scanner or camera capable of discerning reference information. Nutritional substance reader 690 could also be a wireless signal reader, reading RFID labels, or near field IDs. Controller 630 can be a computer, microcontroller, personal computer, laptop computer, tablet computer, or smartphone. Consumer interface 660 can be a standalone touchpad display panel which allows interaction with the consumer, but is preferably integrated into controller 630.

Preferably, consumer module 600 is an integrated device such as a tablet computer or smartphone. In this case, nutritional substance reader 690 could be the camera located on the tablet or smartphone. Consumer interface 660 would be the touchscreen display of the tablet or smartphone. Finally, controller 630 would be the microprocessor in the tablet computer or smartphone. In this embodiment, the software to run consumer module 600 could be an app loaded onto the tablet or smartphone, designed to collect consumer information correlated to a known nutritional substance 620

In operation, consumer 640 would use the camera on the tablet computer or smartphone to read a barcode on nutritional substance 620 providing the reference information for nutritional substance 620. The tablet computer or smartphone would display an appropriate user interface so as to allow consumer 640 to provide information about her consumption of nutritional substance 620. Controller 630 could query nutritional substance database 650 using reference information regarding nutritional substance 620 to determine those in the nutritional substance industry who were involved in the supply chain for nutritional substance 620. Additionally, nutritional substance database 650 could contain information on what information to collect from consumer 640 of the particular nutritional substance 620 being referenced.

Such information could be provided through a connection to the internet accessed through the telecommunication system in the tablet computer or smartphone. Preferably, such a telecommunications connection to nutritional substance database 630 would be a wireless telecommunication system. The tablet computer or smartphone would then, in the same manner, provide the consumer information regarding her consumption of nutritional substance 620 to those in nutritional substance industry 659 involved in the supply chain of nutritional substance 620.

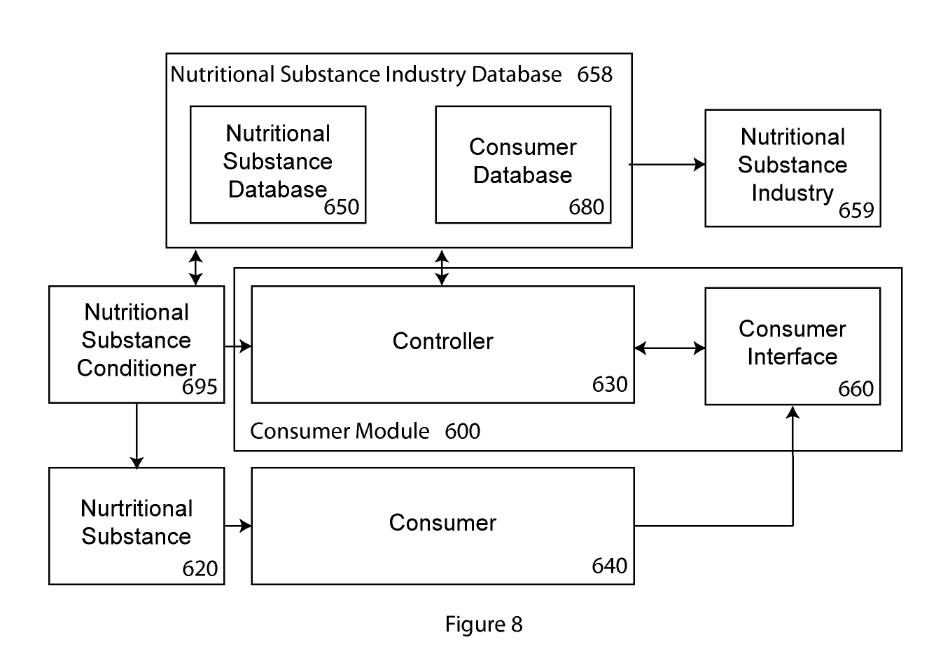

FIG. 8 shows an alternate embodiment of the present invention where nutritional substance 620 was conditioned by nutritional substance conditioner 695. In this case, nutritional substance conditioner 695 would already have information pertaining to nutritional substance 620, including information on how nutritional substance 620 was conditioned by nutritional substance conditioner 695.

In this embodiment, controller 630 receives such information regarding nutritional substance 620 and correlates it with consumer information from consumer interface 660 and provides it to nutritional substance industry 659.

For example, nutritional substance conditioner 695 conditions a ready-to-eat dinner. In the process of conditioning the ready-to-eat dinner, nutritional substance conditioner 695 receives various information, reads the reference tag on nutritional substance 620, the ready-to-eat dinner. Using this reference information, nutritional substance conditioner 695 receives, from nutritional substance database 650, information regarding nutritional substance 620, the ready-to-eat dinner. In this case, if the nutritional substance conditioner 695 is a nutritional substance information ready microwave oven, it would obtain from nutritional substance database 650 preparation information, organoleptic information, and/or nutritional information about the ready-to-eat dinner. Upon presentation of the ready-to-eat dinner to consumer 640, nutritional substance conditioner 695 also provides the information regarding the ready-to-eat dinner it received from nutritional substance database 650 along with information it collected regarding the conditioning of the ready-to-eat dinner by nutritional substance conditioner 695, to controller 630. If consumer module 600 is a standalone device such as a tablet computer or smartphone, the information from nutritional substance conditioner 695 could be transferred by means of a wireless local area network or Bluetooth connection. Consumer module 600, the smartphone for example, would obtain consumer information regarding the consumption of the nutritional substance 620. Since the smartphone knows what was consumed, it can obtain from consumer 640 information appropriate for the ready-to-dinner.

In the case of the ready-to-eat dinner, the consumer 640 could be asked specifically about the taste of the corn and the taste of the beef in the dinner, as well as their combination. Using such information and the information from the nutritional substance database 650, consumer module 600 can provide appropriate information to those in the nutritional substance industry 659 who were involved in the supply chain for nutritional substance 620.

In this embodiment, consumer module 600 could be part of nutritional substance conditioner 695. In this example, the nutritional substance information ready microwave oven would provide user interface 660 to receive consumer information regarding the nutritional substance 620 conditioned by nutritional substance conditioner 695. In such a case, controller 630 likely would be the same controller which operates nutritional substance conditioner 695.

Also included in consumer module 600 is consumer database 680. Consumer database 680 contains specific information regarding consumer 640. Correlated information regarding the consumption of nutritional substance 620 could be stored for future reference in consumer database 680. Such information could be used in collecting future consumer information. For example, if consumer 640 is very particular about a certain aspect of a nutritional substance 620, controller 630 could ask for additional and/or more specific information from consumer 640 about the nutritional substance 620 through consumer interface 660. As an example, consumer 640 is very particular about the texture of pasta. When nutritional substance 620 being consumed by consumer 640 contains pasta, controller 630, in response to historical consumer 640 information in consumer database 680, could ask for additional information regarding the texture of the pasta in nutritional substance 620, using consumer interface 660.

Controller 630 is connected to nutritional substance industry database 658. Nutritional substance industry database 658 contains information regarding nutritional substances 620 in nutritional substance database 650. Also contained in nutritional substance industry database 658 is consumer database 680 which contains information about consumer 640.

In the preferred embodiment of the present invention, nutritional substance industry database is a massive multi-dimension data based used by part or all of the nutritional substance industry to track, store and analyze information about nutritional substances, preservation of nutritional substances, transformation of nutritional substances, conditioning of nutritional substances, recipes for the preparation of nutritional substances, consumption of nutritional substances and marketing of nutritional substances.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. Any claims intended to be treated under 35 U.S.C. §112, ¶ 6 will begin with the words “means for.” Accordingly, the applicant reserves the right to add additional claims after filing the application to pursue such additional claim forms for other aspects of the invention.

1. A communication system for nutritional substances comprising:
an information storage system containing source information regarding a particular nutritional substance;
locator for obtaining consumer information relating to the particular nutritional substance;
retriever for retrieving the information regarding a particular nutritional substance.
transmitter for transmitting the consumer information and source information for the particular nutritional substance.

2. A communication system for nutritional substances comprising:
an information storage system containing source information regarding a particular nutritional substance;
locator for obtaining particular consumer information relating to the particular nutritional substance;
retriever for retrieving the information regarding a particular nutritional substance;
interface for collecting and storing general information regarding the consumer of the particular substance;
transmitter for transmitting the particular and general consumer information and source information for the particular nutritional substance.

3. A communication system for nutritional substances comprising:
an information storage system containing source information regarding a particular nutritional substance;
locator for obtaining consumer information relating to the particular nutritional substance;
transmitter for transmitting the consumer information to the information storage system.

4. A communication system for nutritional substances according to claim 1 wherein said locator comprises a consumer interface for receiving consumer information.

5. A communication system according to claim 1 wherein the information storage system is a multidimensional database.

6. A communication system according to claim 1 wherein said transmitter for the consumer information and source information is a wireless telecommunication system.

7. A communication system for nutritional substances comprising:
an information storage system containing source information regarding a particular nutritional substance;
locator for obtaining consumer information relating to the particular nutritional substance;
transmitter for transmitting the consumer information to the information storage system.

8. A communication system for nutritional substances according to claim 1 wherein locator comprises a consumer interface for receiving consumer information.

9. A communication system according to claim 1 wherein the information storage system is a multidimensional database.

10. A communication system according to claim 1 wherein the transmitter for the consumer information and source information is a wireless telecommunication system.

11. A communication system for nutritional substances comprising:
an information storage system containing source information regarding a particular nutritional substance;
locator for obtaining particular consumer information relating to the particular nutritional substance;
retriever for retrieving the information regarding a particular nutritional substance;
interface for collecting and storing general information regarding the consumer of the particular substance;
transmitter for transmitting the particular and general consumer information and source information for the particular nutritional substance.

12. A communication system according to claim 11 wherein said information storage system comprises a computer.

13. A communication system according to claim 11 wherein said information storage system comprises a database.

14. A communication system according to claim 11 wherein said information storage system comprises an internet database running on one or more servers.

15. A communication system according to claim 11 wherein said locator comprises a computer.

16. A communication system according to claim 11 wherein said locator comprises a database.

17. A communication system according to claim 11 wherein said locator comprises an internet database running on one or more servers.

18. A communication system according to claim 11 wherein said locator comprises:
consumer interface for determining identity of said consumer;
consumer database containing said consumer information reference by said identity of a consumer;
consumer retrieval system for retrieving said consumer information according to said identity of said particular consumer.

19. A communication system of claim 11 wherein said retriever comprises:
identifier associated with a particular nutritional substance;
information storage containing said source information referenced to said identifier; and
nutritional substance locator for retrieving said source information for said particular nutritional substance from said information storage.

20. A communication system for nutritional substances according to claim 12 wherein information storage comprises an electronic storage device or system.

21. A communication system for nutritional substances according to claim 12 wherein information storage comprises a computer.

22. A communication system for nutritional substances according to claim 12 wherein information storage comprises a computer database.

23. A communication system for nutritional substances according to claim 12 wherein such an identifier is a human readable label.

24. A communication system for nutritional substances according to claim 12 wherein such an identifier is a computer readable label.

25. A communication system for nutritional substances according to claim 12 wherein such an identifier is a computer readable label comprising a barcode label.

26. A communication system for nutritional substances according to claim 12 wherein such an identifier is a computer readable label comprising a OR code label.

27. A communication system for nutritional substances according to claim 12 wherein such an identifier is a computer readable label comprising a radio frequency label.

28. A communication system for nutritional substances according to claim 12 wherein such an identifier is a computer readable label comprising an electronically readable label.

29. A communication system for nutritional substances according to claim 12 wherein such reader comprises an optical reader.

30. A communication system for nutritional substances according to claim 12 wherein such reader comprises a radio frequency reader.

31. A communication system for nutritional substances according to claim 12 wherein such reader comprises an electronic reader.

32. A communication system for nutritional substances according to claim 12 wherein such information nutritional substance locator comprises a computer.

33. A communication system for nutritional substances according to claim 12 wherein such information nutritional substance locator comprises a database.

34. A communication system for nutritional substances comprising:
an information storage system containing nutritional, organoleptic and/or aesthetic information regarding a particular nutritional substance;
locator for obtaining particular consumer information relating to the particular nutritional substance;
retriever for retrieving the information regarding a particular nutritional substance;
interface for collecting and storing general information regarding the consumer of the particular substance;
transmitter for transmitting the particular and general consumer information and nutritional, organoleptic and/or aesthetic information for the particular nutritional substance.

35. A communication system according to claim 34 wherein said information storage system comprises a computer.

36. A communication system according to claim 34 wherein said information storage system comprises a database.

37. A communication system according to claim 34 wherein said information storage system comprises an internet database running on one or more servers.

38. A communication system according to claim 34 wherein said locator comprises a computer.

39. A communication system according to claim 34 wherein said locator comprises a database.

40. A communication system according to claim 34 wherein said locator comprises an internet database running on one or more servers.

41. A communication system according to claim 34 wherein said locator comprises:
consumer interface for determining identity of said consumer;
consumer database containing said consumer information reference by said identity of a consumer;
consumer retrieval system for retrieving said consumer information according to said identity of said particular consumer.

42. A communication system of claim 34 wherein said retriever comprises:
identifier associated with a particular nutritional substance;
information storage containing said nutritional, organoleptic and/or aesthetic information referenced to said identifier; and
nutritional substance locator for retrieving said nutritional, organoleptic and/or aesthetic information for said particular nutritional substance from said information storage.

43. A communication system for nutritional substances according to claim 42 wherein information storage comprises an electronic storage device or system.

44. A communication system for nutritional substances according to claim 42 wherein information storage comprises a computer.

45. A communication system for nutritional substances according to claim 42 wherein information storage comprises a computer database.

46. A communication system for nutritional substances according to claim 42 wherein such an identifier is a human readable label.

47. A communication system for nutritional substances according to claim 42 wherein such an identifier is a computer readable label.

48. A communication system for nutritional substances according to claim 42 wherein such an identifier is a computer readable label comprising a barcode label.

49. A communication system for nutritional substances according to claim 42 wherein such an identifier is a computer readable label comprising a OR code label.

50. A communication system for nutritional substances according to claim 42 wherein such an identifier is a computer readable label comprising a radio frequency label.

51. A communication system for nutritional substances according to claim 42 wherein such an identifier is a computer readable label comprising an electronically readable label.

52. A communication system for nutritional substances according to claim 42 wherein such reader comprises an optical reader.

53. A communication system for nutritional substances according to claim 42 wherein such reader comprises a radio frequency reader.

54. A communication system for nutritional substances according to claim 42 wherein such reader comprises an electronic reader.

55. A communication system for nutritional substances according to claim 42 wherein such information nutritional substance locator comprises a computer.

56. A communication system for nutritional substances according to claim 42 wherein such information nutritional substance locator comprises a database.

57. A method of obtaining and associating consumption information of a nutritional substance comprising the steps of:
obtaining consumption information for a particular nutritional substance;
identifying source information for the particular nutritional substance;
associating the consumption information with the source information.
